(19) United States
(12) Patent Application Publication
(10) Pub. No.: US 2012/0226627 A1
(43) Pub. Date: Sep. 6, 2012

(54) SYSTEM AND METHOD FOR BUSINESS REPUTATION SCORING

(76) Inventor: Edward Ming-Yu Yang, La Puente, CA (US)

(21) Appl. No.: 13/041,002

(22) Filed: Mar. 4, 2011

(51) Int. Cl. G06Q 30/00

(52) U.S. Cl. 705/347

(57) ABSTRACT

The present invention generally relates to online business reputations. Specifically, this invention relates to a system and method for analyzing, determining, reporting and modifying an online reputation of a business, professional or individual. The online reputation of a business, professional or individual being comprised of a numeric value, calculated at least in part on positive reviews of the business, professional or individual, negative reviews of the business, professional or individual and the types of websites the positive or negative reviews reside upon.

### FIELD OF THE INVENTION

The present invention generally relates to online business reputations. Specifically, this invention relates to a system and method for analyzing, determining, reporting and modifying an online reputation of a business, professional or individual. The online reputation of a business, professional or individual being comprised of a numeric value, calculated at least in part on positive reviews of the business, professional or individual, negative reviews of the business, professional or individual and the types of websites the positive or negative reviews reside upon.

### BACKGROUND OF THE INVENTION

Today's economy is growing more and more dependent on e-commerce, online transactions and online presences. In large part, the world now requires businesses to have an online presence. Even where businesses have their own online corporate identity, these identities are augmented by an always growing portfolio of data surrounding the business. Each transaction, purchase, interaction with customer support or other event is likely to be noted, most likely permanently, on one or more spaces on the Internet.

The Internet is comprised of thousands of sites where customers may rate businesses, rank businesses, comment on transactions and experiences they have had with businesses and more. Each of these interactions may be viewable by a business's potential customers and clients. Positive and negative alike, every interaction is a fixture that the business may or may not be able to affect.

One major issue is that there is no way currently for a business or a consumer to get an overall rating of a particular business entity. The only way currently for a business or consumer to get an overview of a particular business entity is to scour through potentially hundreds or thousands of web pages looking at reviews and comments about the particular business entity. This can be time consuming and inaccurate as the top results of the particular business entity may be skewed one way (e.g., overly positive, overly negative, overly neutral) while more relevant results may be harder to find.

In any event, if a customer or business wanted to find out the total overall reputation for a particular business, especially large entities which may have hundreds of thousands or millions of interactions available on the Internet, the process would be ultimately be impossible.

Another problem with the current state of the art is that even when a customer or business is able to get a rating of a particular business, there is no way to know if the particular business's ratings are trending in any particular direction. Most rating systems in use today only provide overall rankings or ratings, not trending information. This information may be particularly useful for businesses with imperfect ratings or rankings. If trending information showed a 4 out of 5 star business had improved its ratings drastically over the past few weeks/months/years, a customer may be more inclined to enter into a transaction with that business.

Since there is no way in the current state of the art to identify a business's online reputation, businesses have a hard time identifying areas of particular weaknesses in their online reputation. Without being able to identify the weaknesses in a business's online reputation, it is nearly impossible to make a focused and effective effort to improve a business's overall online reputation.

Therefore, there is a need in the art for a system and method for providing an overall online business reputation score to a user, potentially including reputation trending data points, and present recommendations on how to modify the overall online business reputation score. These and other features and advantages of the present invention will be explained and will become obvious to one skilled in the art through the summary of the invention that follows.

### SUMMARY OF THE INVENTION

The present invention provides users a single networked platform for the determination and analysis of online business reputations, including the ability to recommend particular actions that may be taken to modify the online business reputation of one or more businesses. The platform uniquely combines one or more modules for analyzing and extracting data points that may affect a business's online business reputation from one or more of search engine results, e-commerce site ratings/rankings and social media platforms.

According to an embodiment of the present invention, a server component may provide functionality for utilization of said one or more modules across one or more networks. Additionally, the server component may provide functionality for one or more users to access an online business reputation based at least in part on data received from the one or more modules. Prior to transmitting said online business reputation to said one or more users, the system herein described may generate reports based at least in part on online business reputation and determine recommendations on how to modify said online business reputation. Said reports may be transmitted to said one or more users where desired/requested.

The foregoing summary of the present invention with the preferred embodiments should not be construed to limit the scope of the invention. It should be understood and obvious to one skilled in the art that the embodiments of the invention thus described may be further modified without departing from the spirit and scope of the invention.

### BRIEF DESCRIPTION OF THE DRAWINGS

FIG. 1 is a schematic overview of a network system for carrying out this invention in accordance with an embodiment of the present invention;

FIG. 2 is a schematic of a system in accordance with an embodiment of the present invention;

FIG. 3 is a flowchart describing an exemplary process in accordance with an embodiment of the present invention;

FIG. 4A is a first page of a table showing an online business reputation scoring report in accordance with an embodiment of the present invention;

FIG. 4B is a second page of a table showing an online business reputation scoring report in accordance with an embodiment of the present invention; and

FIG. 4C is a third page of a table showing an online business reputation scoring report in accordance with an embodiment of the present invention.

### DETAILED SPECIFICATION

The present invention generally relates to online business reputations. Specifically, this invention relates to a system and method for analyzing, determining, reporting and modifying an online reputation of a business, professional or individual. The online reputation of a business, professional or individual being comprised of a numeric value, calculated at least in part on positive reviews of the business, professional or individual, negative reviews of the business, professional or individual and the types of websites the positive or negative reviews reside upon.

According to an embodiment of the present invention, the system and method is accomplished through the use of one or more computing devices. One of ordinary skill in the art would appreciate that a computing device appropriate for use with embodiments of the present application may generally be comprised of one or more of a Central Processing Unit (CPU), Random Access Memory (RAM), and a storage medium (e.g., hard disk drive, solid state drive, flash memory). Examples of computing devices usable with embodiments of the present invention include, but are not limited to, personal computers, smart phones, laptops, mobile computing devices, and servers. One of ordinary skill in the art would understand that any number of computing devices could be used, and embodiments of the present invention are contemplated for use with any computing device.

In an exemplary embodiment according to the present invention, data may be provided to the system, stored by the system and provided by the system to users of the system across local area networks (LANs) (e.g., office networks, home networks) or wide area networks (WANs) (e.g., the Internet). In accordance with the previous embodiment, the system may be comprised of numerous servers communicatively connected across one or more LANs and/or WANs. One of ordinary skill in the art would appreciate that there are numerous manners in which the system could be configured and embodiments of the present invention are contemplated for use with any configuration.

In general, the system and methods provided herein may be consumed by a user of a computing device whether connected to a network or not. According to an embodiment of the present invention, some of the applications of the present invention may not be accessible when not connected to a network, however a user may be able to compose data offline that will be consumed by the system when the user is later connected to a network.

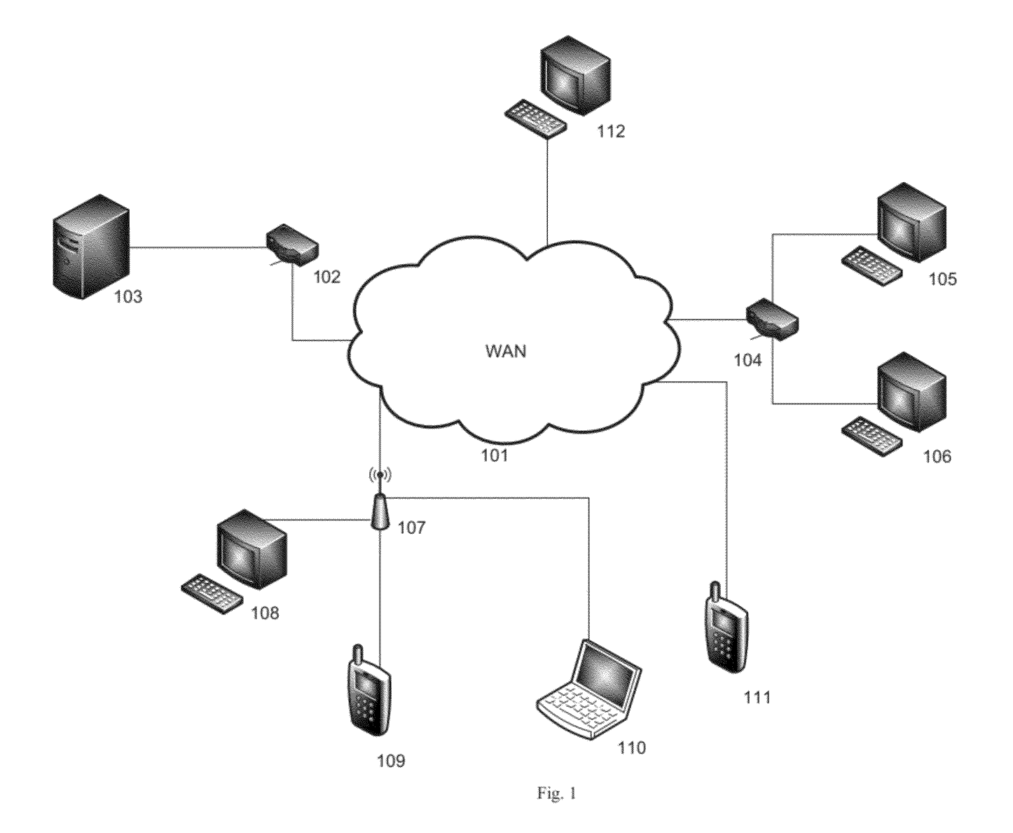

Referring to FIG. 1, a schematic overview of a system in accordance with an embodiment of the present invention is shown. The system is comprised of one or more application servers 103 for electronically receiving, processing and storing information used by the system. Modules in the server 103 may retrieve and manipulate information in storage devices and exchange information through a WAN 101 (e.g., the Internet).

According to an exemplary embodiment, as shown in FIG. 1, exchange of information through the WAN 101 or other network may occur through one or more high speed connections directed through one or more routers 102. Router(s) 102 are completely optional and other embodiments in accordance with the present invention may or may not utilize one or more routers 102. One of ordinary skill in the art would appreciate that there are numerous ways server 103 may connect to WAN 101 for the exchange of information, and embodiments of the present invention are contemplated for use with any method for connecting to networks for the purpose of exchanging information.

Users may connect to server 103 via WAN 101 or other network in numerous ways. For instance, a user may connect to the system i) through a computing device 112 directly connected to the WAN 101, ii) through a computing device 105, 106 connected to the WAN 101 through a routing device 104, iii) through a computing device 108, 109, 110 connected to a wireless access point 107 or iv) through a computing device 111 via a wireless connection (e.g., CDMA, GMS, 3G, 4G) to the WAN 101. One of ordinary skill in the art would appreciate that there are numerous ways that a user may connect to Server 103 via WAN 101 or other network, and embodiments of the present invention are contemplated for use with any method for connecting to Server 103 via WAN 101 or other network.

According to an embodiment of the present invention, an individual or organization may signup to become a user of the system herein provided. In an exemplary embodiment, an individual or organization would go through a registration process, whereby they would provide identifying information to be stored in application server 103. This identifying information may be used, for instance, to identify the user, secure their login or process financial transactions. One of ordinary skill in the art would appreciate there are numerous ways to provide and manage registration processes, and embodiments of the present invention are contemplated for use with any method for providing and managing registration processes.

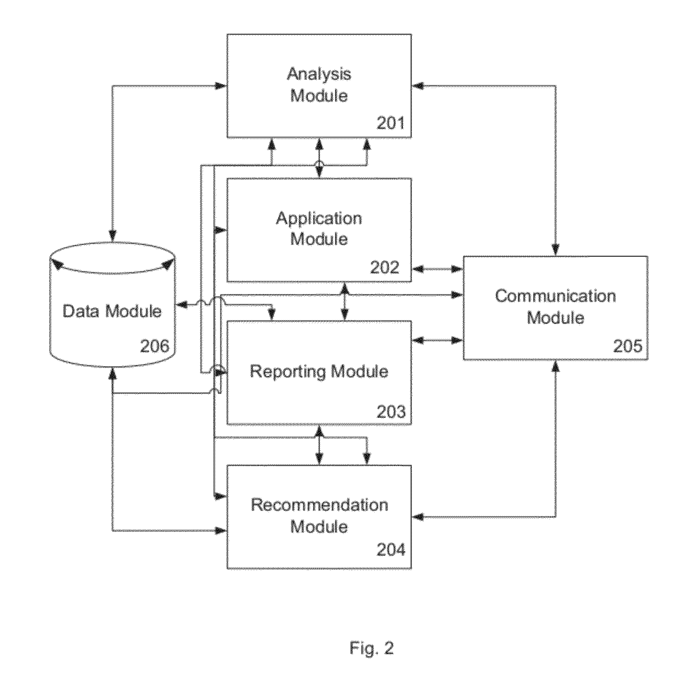

Turning now to FIG. 2, an exemplary embodiment of a system in accordance with an embodiment of the present invention, is described. In this embodiment, the system is comprised of an analysis module 201, an application module 202, a reporting module 203, a recommendation module 204, a communication module 205 and a data module 206. One of ordinary skill in the art would appreciate that these modules could be located on a single computing device or multiple computing devices communicatively connected to one another.

According to an embodiment of the present invention, an analysis module 201 provides functionality to the system for analyzing online entities for interactions pertaining to one or more businesses. Online entities include, but are not limited to, websites, search engines, e-commerce sites, blogs, social network platforms, new media platforms, RSS feeds and business review sites. Interactions include, but are not limited to, ratings, reviews, blog posts, news posts, tweets, social network comments, page ranking statistics and business bureau results. One of ordinary skill in the art would appreciate that there are numerous online entities and interactions that could be analyzed by an analysis module 201 in accordance with an embodiment of the present invention, and embodiments of the present invention are contemplated for use with any type of online entity and interaction.

According to an embodiment of the present invention, an analysis module 201 may be configured to request and receive information from one or more of a communication module 205 and/or a data module 206. Typically, the analysis module 201, in conjunction with the one or more communication modules 205, searches numerous online entities for interactions related to a particular business, professional or individual. Optionally, the analysis module 201, may also search information stored at one or more data modules 206 for previously stored interactions related to a particular business, professional or individual.

According to an embodiment of the present invention, an analysis module 201 is configured to analyze interactions for their quality and type. For instance, an analysis module 201 may be configured to identify whether a particular interaction is a positive interaction (e.g., good review of a business, professional or individual or their products or services) or a negative interaction (e.g., a bad review of a business, professional or individual or their products or services). The analysis module 201 may be further configured to weight the importance of a particular interaction. For example, an analysis module 201 may weight an interaction found on various websites differently based on, for instance, the difficulty of removing or changing a negative review. One of ordinary skill in the art would appreciate that there are numerous ways for an interaction to be weighted, and embodiments of the present invention are contemplated for use with any method for weighting interactions.

According to an embodiment of the present invention, an application module 202 may be utilized to manage a user's experience with the system. The application module 202 may be configured to allow users to login, request online business reputation scores for one or more business entities, requests reports related to one or more business entities, make financial transactions related to membership fees and other actions common to modules for managing user experience. It should be noted that an online business reputation score as used herein could also denote a reputation score for a professional or an individual and the term online business reputation score is being utilized for simplicity. Additionally, where a comment is made in the present application in regards to a business or one or more businesses, the substitution of a professional or individual may also be appropriate.

According to an embodiment of the present invention, a reporting module 203 may be utilized to generate reports related to one or more online business reputation scores. In order to generate reports, the reporting module 203 may receive information from one or more of a analysis module 201, an application module 202, a recommendation module 204, a communications module 205, and a data module 206. Reports may include, but are not limited to, a current online business reputation score, historical online business reputation scores, trending information related to one or more online business reputation scores, trending information comparing trends related to two or more businesses, recommendations related to historical online business reputation scores, recommendations related to current online business reputation scores and recommendations related to desired online business reputation scores.

According to an embodiment of the present invention, a reporting module 203 may be configured to provide reports to users in one or more formats. Report formats include, but are not limited to, Word documents, text documents, PDFs, XML, JSON, e-mail, HTML, PowerPoint, Excel and comma-separated values (CSV). The reports may also be provided via one or more application programming interfaces (API) to be consumed by third-party applications. Advantageously, through the use of APIs, reports generated by the systems and methods herein described may be provided to and consumed by users of third-party systems.

According to an embodiment of the present invention, a recommendation module 204 may be utilized to make specific and general recommendations to users based on analyzed interactions provided by an analysis module 201. In this manner, businesses may be provided with more than just an online business reputation score. Advantageously, the system and methods herein described may not only allow businesses to know how they are viewed in the public, but take actions to improve their online business reputation score.

According to an alternative embodiment of the present invention, a recommendation module 204 may be utilized to make specific and general recommendations to users on how to lower an online business reputation score. While most typically, the system and methods herein described will be utilized to improve an online reputation score, recommendations may also be provided for lowering an online business reputation score. For example, a business may wish to take actions to lower the online business reputation score of a competitor. In this manner, the recommendation module 204 could provide recommendations on how to effectively reduce their competitors online business reputation score.

According to an embodiment of the present invention, a communication module 205 may be utilized to handle communications to and from the systems herein described. Communication modules 205 may be comprised of a mixture of hardware and software and designed to interconnect one or more computing devices to one or more of a LAN or WAN. The communication module 205, may be an integrated part of the system herein described or communicatively connected in a manner to allow for attachment and detachment at will.

According to an embodiment of the present invention, a data module 206 may be utilized to handle storage of relevant information to be used by the systems herein described. Data module 206 may be comprised of a mixture of hardware and software designed to allow for the temporary or permanent storage of data to be accessed by a system. Data modules 206 include, but are not limited to databases, storage mediums and random access memory.

According to an embodiment of the present invention, analysis module 201 is communicatively connected to one or more of an application module 202, a reporting module 203, a recommendation module 204, a communications module 205 and a data module 206.

According to an embodiment of the present invention, application module 202 is communicatively connected to one or more of an analysis module 201, a reporting module 203, a recommendation module 204, a communications module 205 and a data module 206.

According to an embodiment of the present invention, reporting module 203 is communicatively connected to one or more of an analysis module 201, an application module 202, a recommendation module 204, a communications module 205 and a data module 206.

According to an embodiment of the present invention, recommendation module 204 is communicatively connected to one or more of an analysis module 201, an application module 202, a reporting module 203, a communications module 205 and a data module 206.

According to an embodiment of the present invention, communication module 205 is communicatively connected to one or more of an analysis module 201, an application module 202, a reporting module 203, a recommendation module 204 and a data module 206.

According to an embodiment of the present invention, data module 206 is communicatively connected to one or more of an analysis module 201, an application module 202, a reporting module 203, a recommendation module 204, a communications module 205.

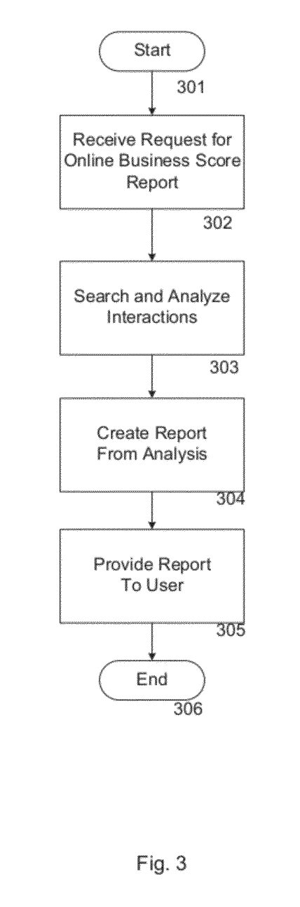

Turning now to FIG. 3, an exemplary process in accordance with the present invention is shown. The process starts at step 301, when a user logs into the system. The user may log in via an application module 202 provided by the system.

At step 302, the user sends to the system a request for an analysis and report of an online business reputation score of a particular business. Typically, this sort of request will be made over a network to the system which is located remotely from the user's computing device. For instance, this request may be received at a website contacted by the user utilizing a computing device connected to the Internet. The request may be received, for instance, at a communications module 205 of the system.

At step 303, the request is sent to an analysis module 201 for processing. At this point, the analysis module 201 may perform a search of one or more networks and storage mediums for interactions related to a business. The analysis module 201 will review and rank/rate each interaction individually and generate an online business reputation score based on predetermined algorithms for reviewing and weighting various interactions.

According to an embodiment of the present invention, Particular searches may be configured to suit the needs of a particular user. For instance, some users may only desire to have a standard search performed. A standard search may limit itself to only the first few dozen results returned. Other users may require in depth searches, requiring the search and analysis of various levels of interactions, no matter how remote. The more in depth the search, the more resources will be utilized and the more time or processing power may be consumed in order to generate the appropriate analysis of the interactions.

Once the analysis is complete, the process moves to step 304 at which point the system begins to generate a report based on the analysis provided from the analysis module 201. Optionally, the system may choose to store certain interactions and analyses identified and performed in step 303 in one or more data modules 206 to be utilized in future analysis and reports.

According to an embodiment of the present invention, prior to generating a report based on the analysis, the analysis data may be passed to one or more recommendation modules 204. The one or more recommendation modules 204 may utilize the analysis data to generate one or more recommendations on how to modify the analyzed online business reputation score. The one or more recommendation modules 204 may be configured in such a manner as to only provide recommendations that may be pertinent to the particular user's goals. For instance, a user who has been identified as a small business may not be presented a recommendation to hire an expensive public relations firm in order to improve their online business reputation score. Once the appropriate recommendations have been identified, the recommendation information may be sent to the reporting module 203 for addition in the report to be generated for the user.

At step 305, the generated report is transmitted from the reporting module 203 to the user, via the communications module 205. The report may be transmitted in any of the previously described manners, including transmittal through the use of an API for consumption by third-party services prior to being received by the user.

The process ends at step 306, with the user receiving the requested online business reputation score report. The previous steps are merely for example purposes. The steps are not required to be executed in this order, and one of ordinary skill in the art would appreciate that these steps could be executed in a variety of different manners as well as having two or more of the steps executing simultaneously.

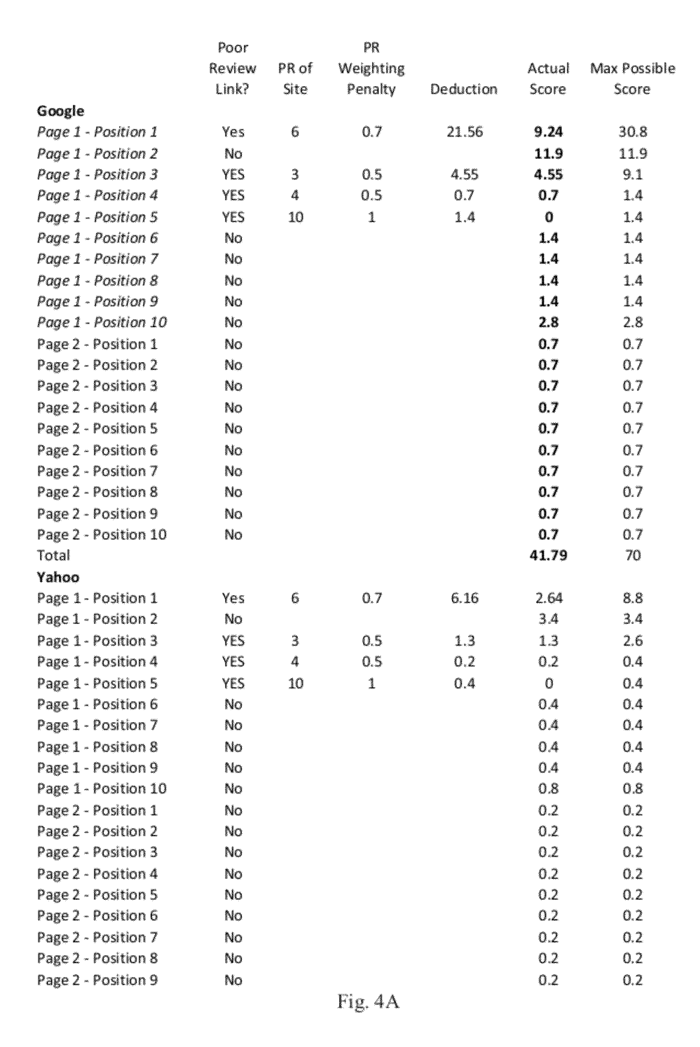

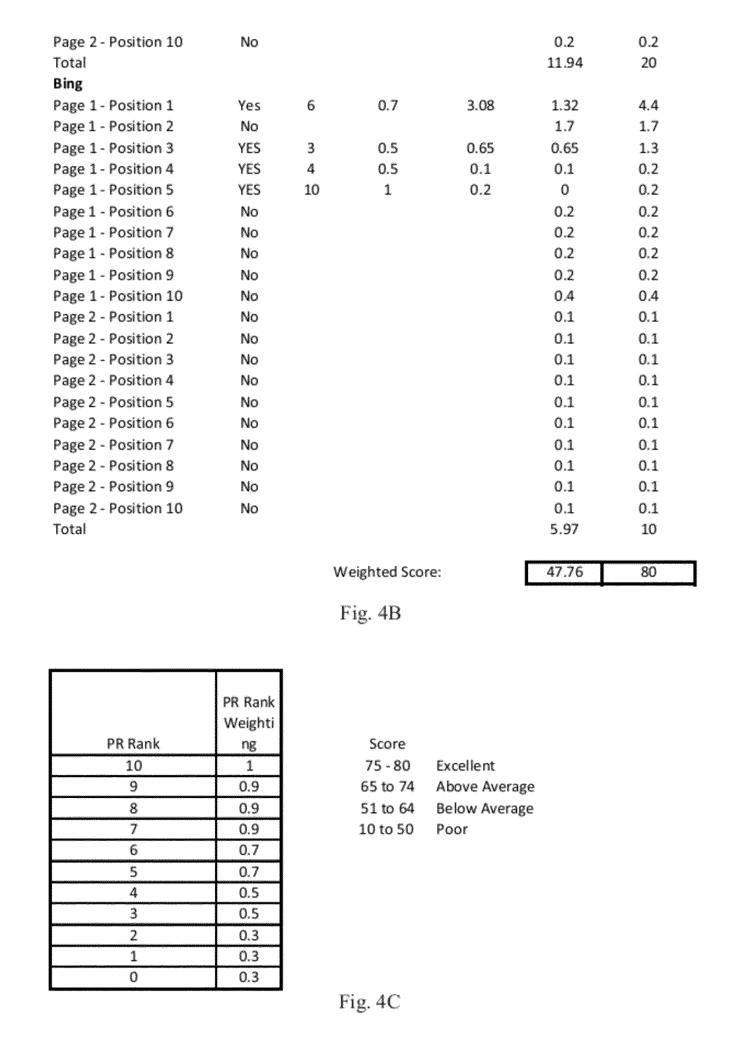

Turing now to FIGS. 4A-4C, a table is shown that represents an online business reputation score report in accordance with an embodiment of the present invention. The online business reputation score report in this embodiment is comprised of numerous weighted rankings of entities based in part upon their position, type and origin. The final score is weighted to fit a scale of 10-80 points. Once the final score has been weighted, the report may be provided to the user and also present a breakdown of how good their score is (e.g., 75-80 is excellent, 65-74 is above average, 51-64 is below average and 10-50 is poor).

While multiple embodiments are disclosed, still other embodiments of the present invention will become apparent to those skilled in the art from this detailed description. The invention is capable of myriad modifications in various obvious aspects, all without departing from the spirit and scope of the present invention. Accordingly, the drawings and descriptions are to be regarded as illustrative in nature and not restrictive.

1. A method for providing an online business reputation score, said method comprising:
receiving, at an application server, a request from a user for information related to a first business;
identifying, at said application server, said first business;
searching, utilizing said application server, a plurality of online entities for one or more interactions related to said first business;
analyzing, at said application server, said one or more interactions related to said first business to form a business reputation score;
determining, at said application server, one or more recommendations to modify said online business reputation score based at least in part on said one or more interactions;
creating, at said application server, an online business reputation report based at least in part on said one or more recommendations and said online business reputation score; and
providing, from said application server, to said user, said online business reputation report.

2. The method of claim 1, wherein at least one of said plurality of online entities is a search engine.

3. The method of claim 1, wherein at least one of said plurality of online entities is a social media platform.

4. The method of claim 1, wherein at least one of said plurality of online entities is an e-commerce website.

5. The method of claim 1, wherein at least one of said one or more interactions is a business review.

6. The method of claim 1, wherein at least one of said one or more interactions is a customer review.

7. The method of claim 1, wherein at least one of said one or more interactions is a forum post.

8. The method of claim 1, wherein at least one of said one or more interactions is a social media communication.

9. The method of claim 1, wherein at least one of said one or more recommendations is an optimization based in part on search engine ranking results.

10. The method of claim 1, wherein at least one of said one or more recommendations is a recommendation to respond to one or more of said one or more interactions.

11. A system for providing an online business reputation score, the system comprising:
an application module,
wherein said application module is configured to receive a request for an online business reputation score from a user,
wherein said online business reputation score pertains to a first business;
an analysis module communicatively connected to said application module,
wherein said analysis module is configured to search and analyze a plurality of online entities for one or more interactions related to said first business; and
a reporting module communicatively connected to said analysis module and said application module,
wherein said reporting module is configured to generate a report comprised of an online business reputation score,
wherein said report is based, at least in part, on information received from said analysis module.

12. The system of claim 11, wherein at least one of said plurality of online entities is a search engine.

13. The system of claim 11, wherein at least one of said plurality of online entities is a social media platform.

14. The system of claim 11, wherein at least one of said plurality of online entities is an e-commerce website.

15. The system of claim 11, wherein at least one of said one or more interactions is a business review.

16. The system of claim 11, wherein at least one of said one or more interactions is a customer review.

17. The system of claim 11, wherein at least one of said one or more interactions is a forum post.

18. The system of claim 11, wherein at least one of said one or more interactions is a social media communication.

19. The system of claim 11, further comprising:
a recommendation module communicatively connected to said application module, said analysis module and said reporting module,
wherein said recommendation module is configured to provide recommendations to said reporting module.

20. The system of claim 18, wherein said recommendations are comprised of one or more recommendations on how to modify said online business reputation score.
